(19) United States
(12) Patent Application Publication
(10) Pub. No.: US 2006/0172842 A1
(43) Pub. Date: Aug. 3, 2006

(54) Cold-resistant roller chain

(76) Inventor: Hiroshi Kamon, Osaka (JP)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/316,662

(22) Filed: Dec. 22, 2005

(30) Foreign Application Priority Data
Feb. 2, 2005 (JP) 2005-026501

(51) Int. Cl. F16G 13/02

(52) U.S. Cl. 474/206

(57) ABSTRACT

A roller chain and a method of making a roller chain are described. The roller chain according to the present invention includes inner plates, outer plates, and pins that are formed of a chromium-molybdenum steel alloy having the following composition in weight percent:

| | |
|---|---|
| C | 0.33 to 0.38 |
| Si | 0.15 to 0.35 |
| Mn | 0.60 to 0.90 |
| P | 0.030 or less |
| S | 0.030 or less |
| Ni | 0.25 or less |
| Cr | 0.90 to 1.20 |
| Mo | 0.15 to 0.30 |

The balance is iron and unavoidable impurities. The alloy is subjected to a hardening heat treatment to provide the desired properties of hardness and strength. The disclosed chain and method provide a cold-resistant roller chain that is better adapted for use at very low temperatures of −10° C. or lower than the known roller chains.

### TECHNICAL FIELD OF THE INVENTION

The present invention relates generally to roller chains, and in particular to a roller chain used at temperatures of −10° C. and lower such as in a refrigeration room or other extremely cold environment.

### BACKGROUND TECHNOLOGY

The known roller chains are manufactured with various materials, typically steel alloys that are given a heat treatment to provide desired properties under a wide range of environmental conditions. More specifically, the plates in such chains are formed of a JIS S55C steel alloy and hardened by appropriate heat treatment. The pins and bushings used in the known chains are formed of a JIS SMn420 steel alloy and subjected to a carburization treatment. The rollers used in the chains are formed of a JIS SMn438 steel alloy. See, for example, M. Nakagome, “Story of Chain”, Japanese Standards Organization, p. 81 to 83 (Jan. 20, 1997).

However, in the design of the known roller chains, no consideration has been given for the situation where the roller chain is used under very low temperature conditions, such as −10° C. or lower. Such temperatures are present in a refrigeration room and other extremely cold environments. When a conventional roller chain is used under such low temperature conditions, problems have occurred because of reductions in fatigue strength and impact resistance that result from low-temperature brittleness.

Accordingly, it is an object of the present invention to solve the problems associated with use of a conventional roller chain in a very low temperature environment, and to provide a roller chain that is suitable for use at a temperature of −10° C. or lower.

### SUMMARY OF THE INVENTION

In accordance with one aspect of the present invention there is provided a roller chain having an inner link in which both ends of two bushings are respectively press-fitted into corresponding bushing holes formed in a pair of inner plates. The inner link preferably has a rotatable roller positioned around the outside of each bushing. A pair of outer plates is connected to the inner link by two pins slidably positioned inside the bushings of the inner link. The ends of the pins are respectively press-fitted into corresponding pin holes formed in the outer plates. The outer plates are positioned on outsides of the inner plates to form an outer link. Combinations of the inner link and the outer link are connected together to form the roller chain. The inner plates, the outer plates, and the pins are formed of a steel alloy having the following composition in weight percent:

| | |
|---|---|
| C | 0.33 to 0.38 |
| Si | 0.15 to 0.35 |
| Mn | 0.60 to 0.90 |
| P | 0.030 or less |
| S | 0.030 or less |
| Ni | 0.25 or less |
| Cr | 0.90 to 1.20 |
| Mo | 0.15 to 0.30 |

and the balance being iron and unavoidable impurities. The alloy is subjected to a hardening heat treatment to provide the desired properties of hardness and strength. The steel alloy corresponds to the chromium molybdenum steel SCM435 defined in JIS G4106 (1979).

In accordance with another aspect of the present invention there is provided a method of making a roller chain which includes the step of forming at least two inner plates, at least two outer plates, and at least two pins from a steel alloy having the following weight percent composition:

| | |
|---|---|
| C | 0.33 to 0.38 |
| Si | 0.15 to 0.35 |
| Mn | 0.60 to 0.90 |
| P | 0.030 or less |
| S | 0.030 or less |
| Ni | 0.25 or less |
| Cr | 0.90 to 1.20 |
| Mo | 0.15 to 0.30 |

and the balance being iron and unavoidable impurities. Bushing holes are formed in the inner plates and pin holes are formed in the outer plates. The process also includes the step of heat treating the inner plates, the outer plates, and the pins to provide a desired combination of hardness and strength. At least two steel bushings are also provided. The inner plates and the bushings are assembled by press-fitting the ends of the bushings into respective bushing holes in the inner plates to form a plurality of inner links. The pins are slidably positioned in the bushings and have their ends press-fitted into the pin holes of pairs of the outer plates to form outer links that are thereby connected to the inner links to form a chain. Steel rollers are preferably positioned around the bushings such that they can rotate about the bushings.

By forming the inner plate, the outer plate, and the pin of SCM435 the problem of a reduction in strength when the chain is subjected to a very low temperature is significantly resolved, so that the resistance of the roller chain to brittle fracture or cracking is remarkably improved.

It is noted that although a roller chain in accordance with this invention may include a roller that is fitted onto the bushing in an inner link, the invention also encompasses a roller chain which does not include such rollers.

### BRIEF DESCRIPTION OF THE DRAWING

FIG. 1 is a perspective view showing the structure of an embodiment of a roller chain according to the present invention; and

FIG. 2 is a table showing the results of comparative impact testing of a pin material used in a chain according to the present invention.

### DESCRIPTION OF A PREFERRED EMBODIMENT OF THE INVENTION

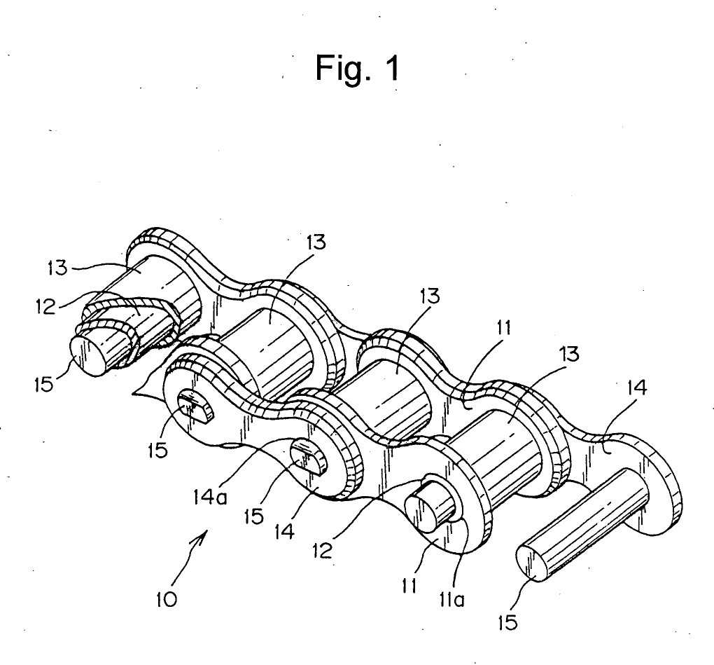

An embodiment of the present invention will be described in connection with the following example. As shown in FIG. 1, a roller chain 10 includes inner links each of which has a pair of inner plates 11, a pair of bushings 12, and a pair of rollers 13. The ends of the bushings 12 are respectively press-fitted into bushing holes 11a formed in the inner plates 11. Each inner link preferably has rotatable rollers 13 positioned on the outsides of the bushings 12. The chain 10 also includes outer links each of which has a pair of outer plates 14. Two pins 15 are slidably positioned inside the bushings 12 of the inner link. The ends of the pins 15 are respectively press-fitted into pin holes 14a formed in the outer plates 14. The outer plates 14 are positioned outwardly of the inner plates 11 and connected thereto by the pins 15. The chain 10 is formed by alternately connecting a plurality of the inner links to the outer links with the pins 15.

The inner plates 11, the outer plates 14, and the pins 15 are subjected to tensile stress when the chain 10 is in use. Therefore, the inner plates 11, the outer plates 14, and the pins 15 are formed of a steel, JIS SCM435, having the following composition, C: 0.33 to 0.38 weight %, Si: 0.15 to 0.35 weight %, Mn: 0.60 to 0.90 weight %, P: 0.030 weight % or less, S: 0.030 weight % or less, Ni: 0.25 weight % or less, Cr: 0.90 to 1.20 weight %, Mo: 0.15 to 0.30 weight %, and the rest of iron and unavoidable impurities. The parts formed from the alloy are given a hardening heat treatment to provide the desired levels of hardness and strength.

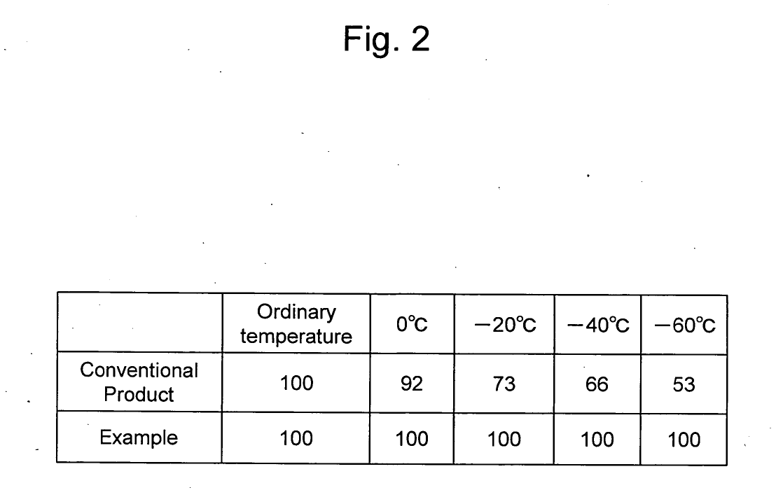

FIG. 2 shows the results of comparative testing of a sample (Conventional Product) of SMn420, which is widely used as a pin material, and a sample (Example) of SCM435 which is used as the pin material in a chain according to the present invention. Both test samples were subjected to a hardening treatment. The hardened specimens were then subjected to impact toughness testing. The measured test data were normalized so that each material provides a value of 100 at ordinary temperature. It can be seen from the test data presented in FIG. 2 that the sample of SCM435 provides significantly better resistance to cold-induced embrittlement down to a temperature of −60° C. compared to the Conventional Product. Therefore, a chain made in accordance with the present invention is significantly more resistant to the adverse effect of very low temperature on the toughness property.

Further, since the hardened sample of the SCM435 alloy does not undergo a reduction in the impact value even at very low temperatures, it has also been found that any reduction in the strength provided by the sample at very low temperatures is significantly smaller than the loss of strength realized by the Conventional Product, JIS S55C. Consequently, the impact resistance and fatigue strength of the sample are superior to the conventional alloy.

The present inventor has carefully studied the properties of a chain under very low temperature conditions as described above. Such properties have not been studied sufficiently previously. As a result of those investigations, a chain has been developed which does not experience a significant loss of strength at a very low temperature of −10° C. or less. This advantage is realized by specifying the JIS SCM435 alloy as the plate material and the pin material because those components are subjected to tensile stress that is imposed on the chain during operation. Thus the chain of the present invention has extremely large industrial applicability.

What is claimed is:

1. A cold-resistant roller chain comprising:
A plurality of inner links each inner link having:
a pair of inner plates having at least two bushing holes formed therein; and
a pair of bushings, each having ends that are respectively press-fitted into the bushing holes in said pair of inner plates; and
a plurality of outer links, each outer link having:
a pair of outer plates having at least two pin holes formed therein, said outer plates being arranged on outward-facing sides of said pair of inner plates; and
a pair of pins slidably positioned inside said bushing, said pins having ends that are respectively press-fitted into the pin holes in said pair of outer plates whereby the outer links are flexibly connected to the inner links;
wherein said inner plates, said outer plates and said pins are formed of a steel alloy having the following-weight percent composition, C: 0.33 to 0.38 weight %, Si: 0.15 to-0.35 weight %, Mn: 0.60 to 0.90 weight %, P: 0.030 weight % or less, S: 0.030 weight % or less, Ni: 0.25 weight % or less, Cr: 0.90 to 1.20 weight %, Mo: 0.15 to 0.30 weight %, and the being iron and unavoidable impurities.

2. A cold-resistant roller chain as claimed in claim 1 wherein the inner plates, the outer plates, and the pin are hardened by a hardening heat treatment.

3. A cold-resistant roller chain as claimed in claim 1 comprising a pair of rotatable rollers positioned on the outsides of respective ones of said bushings.

4. A method of making a roller chain comprising the steps of:
Forming a pair of inner plates from a steel alloy having the following weight percent composition, C: 0.33 to 0.38 weight %, Si: 0.15 to 0.35 weight %, Mn: 0.60 to 0.90 weight %, P: 0.030 weight % or less, S: 0.030 weight % or less, Ni: 0.25 weight % or less, Cr: 0.90 to 1.20 weight %, Mo: 0.15 to 0.30 weight %, and the being iron and unavoidable impurities, said inner plates having at least two bushing holes formed therein;
forming a pair of steel bushings;
forming a pair of pins from said steel alloy;
forming a pair of outer plates from said steel alloy, said outer plates having at least two pin holes formed therein;
press fitting ends of said bushings into the bushing holes in said inner plates;
inserting said pins into said bushings; and press fitting ends of said pins into the pin holes in said outer plates.

5. A method as claimed in claim 4 comprising the step of hardening said inner plates, said pins, and said outer plates by a hardening heat treatment.

6. A method as claimed in claim 4 comprising the steps of:
forming a pair of steel rollers; and
positioning said rollers around respective ones of said bushings such that each of said rollers is free to rotate around its respective bushing.
